(19) United States
(12) Patent Application Publication
(10) Pub. No.: US 2007/0126148 A1
(43) Pub. Date: Jun. 7, 2007

(54) MICROSTRUCTURED EMBOSSING DRUM AND ARTICLES MADE THEREFROM

(75) Inventors: Dennis Joseph Coyle, Clifton Park, NY (US); Scott Miller, Clifton Park, NY (US); Kenneth Paul Zarnoch, Scotia, NY (US); Erwin Wenti Liang, Cerritos, CA (US)

Correspondence Address: CANTOR COLBURN, LLP, 55 GRIFFIN ROAD SOUTH, BLOOMFIELD, CT, 06002, US

(73) Assignee: GENERAL ELECTRIC COMPANY, Schenectady, NY (US)

(21) Appl. No.: 11/563,361

(22) Filed: Nov. 27, 2006

Related U.S. Application Data
(63) Continuation-in-part of application No. 11/292,509, filed on Dec. 2, 2005.

(51) Int. Cl. B28B 1/14

(52) U.S. Cl. 264/299; 425/471

(57) ABSTRACT

Disclosed herein are embossing drums, systems, methods for their use and their maintenance, and films made using the drums. In one embodiment, an embossing drum system can comprise: a mandrel, a primary journal extending from a first end of the mandrel, a secondary journal extending from a second end of the journal, and a seamless sleeve disposed around the mandrel to form a drum. The sleeve comprises a pattern cut into a sleeve outer surface. In one embodiment, a method of making optical films, comprises: introducing a polymer to an embossing drum system, forming the pattern into a surface of the polymer to produce a film, and removing the film from the drum. The embossing drum system comprises a drum with a pattern cut into a drum outer surface. The film has a continuous, seamless pattern having a length that is greater than the drum circumference.

### CROSS-REFERENCE TO RELATED APPLICATION

This application is a continuation-in-part and claims the benefit of the filing date of U.S. patent application Ser. No. 11/292,509 filed Dec. 2, 2005, which is incorporated herein by reference.

### BACKGROUND

Embossed films comprising specialized geometric patterns are capable of directing, diffusing, and polarizing light. These films are desirable in many applications, such as backlight displays (e.g., flat screen monitors); wherein the light emitted from the display can be directing light along the viewing axis (i.e., an axis normal (perpendicular) to the display), which enhances the perceived display brightness, while operating at reduced power consumption. The geometric patterns employed in these films can comprise prismatic features such as pyramidal or triangular elements to achieve the light directing properties. These elements can be produced utilizing several methods, such as the ultraviolet cast and cure method or the hot embossing method. In the ultraviolet cast and cure method, a photocurable liquid polymer can be distributed between an embossing drum and a thin polymer sheet. Tension on the polymer sheet and/or pressure from a rubber-covered nip roll assists to flow the polymer into the patterns on the drum surface and displacing excess polymer from the interface of the drum and the film. An ultraviolet light source can then employed to cure the polymer, which adheres to the film, creating an embossed film. The embossed film can then be stripped from the drum for further processing. The hot-embossing process comprises heating a polymer film above its glass transition temperature and forcing the film against an embossing drum. The heated polymer can flow into the surface features of the embossing drum and then cooled so that the shape of the features is retained in the film, which can then be stripped from the drum for further processing.

The quality of the resulting optical films is dependent on the quality of replication of the surface features. Therefore, if the drum's surface incurs damage (e.g., dings, scratches, warpage), or wears to the point where the optical film produced exhibits marginal optical performance, the drum must be repaired. There are two methods for providing surface features on a drum. The first is to pattern the surface of the drum itself via such processes as micromachining, photolithography, etching, laser-writing, and so forth. To repair such an embossing drum, the embossing line is shutdown to allow access to the drum, and then the drum is removed from the machine and replaced. This involves shutting down the coating line, disconnecting cooling water lines and mechanical drive components such as belts, pulleys, motors, and gearboxes, and then removing the drum completely from the machine. A new drum is then installed in the reverse manner. This can take several hours of labor to accomplish.

The second method of providing surface features on a drum is to first create a thin tool, such as an electroform, and attach it to the surface of a smooth surfaced drum via clamps, adhesives, or the like. When this tool is damaged or worn it must be replaced. This involves shutting down the coating machine, stripping off the tool, and mounting a new one on the casting drum. This can take anywhere from 1 to 3 hours, depending on operator skill. In addition the operator must get clear access to the casting drum, which typically has a nip roll, one or two UV lamps, and a stripper roll, all mounted very close to the drum making the job difficult. This procedure affects the economic performance of the film manufacturing, and is therefore desirably as short as possible. In addition, it is difficult to mount such a tool on the coating machine straight and properly registered or aligned with the machine.

A further problem with producing the films is the amount of waste created due to the need to perform patch film formation. The tool (e.g., electroform) is a discrete rectangular piece so that coating is applied in patches aligned with the tool. Overcoating the ends of the tool will cause it to be ripped from the drum or damaged. Patch coating uses a more complex coating machine. The electroform is created in an electroforming operation; essentially in another factory. The electroform production and use incites a lot of waste of materials and machine capacity; the area between patches and the starting and trailing ends of the patches are scrap. Additionally, in general, the product size (e.g., rectangular pieces that fit one particular LCD display) does not make efficient use of the patch size, thereby generating even more scrap.

An alternative approach is to weld or otherwise join the two ends of the electroform to form a cylindrical sleeve mounted on the mandrel. However, the joint must be smooth enough to coat over without creating coating flakes or a bump that will mark (put defects into) the coated film once it is wound into a roll. Furthermore, the joint is still an imperfection that is die-cut from in-between the seams.

What is continually needed in the art are methods and equipment to simplify repair processes and reduce repair times, and/or to reduce waste, process time, and/or equipment. For example, what are needed in the embossing industry are devices and methods that allow for the replacement of embossing drums (and similar devices) in a reduced amount of time.

### SUMMARY

Disclosed herein are embossing drum systems, methods for their use, methods for their maintenance, and films made using the drums.

In one embodiment, an embossing drum system can comprise: a mandrel having a mandrel outer surface, a primary journal extending from a first end of the mandrel, a secondary journal extending from a second end of the journal, and a seamless sleeve disposed around the mandrel to form a drum. The sleeve comprises a pattern cut into a sleeve outer surface.

In another embodiment, an embossing drum system comprises: a seamless drum having a substantially constant outer diameter, a primary journal extending from a first end of the mandrel, and a secondary journal extending from a second end of the journal. The drum comprises a pattern cut into an outer surface of the drum.

In one embodiment, a method of making optical films, comprises: introducing a polymer to an embossing drum system, forming the pattern into a surface of the polymer to produce a film, and removing the film from the drum. The embossing drum system comprises a drum with a pattern cut into a drum outer surface. The film has a continuous, seamless pattern having a length that is greater than the drum circumference.

The above described and other features are exemplified by the following figures and detailed description.

### BRIEF DESCRIPTION OF THE DRAWINGS

Refer now to the figures, which are meant to be exemplary and not limiting, and wherein like elements are numbered alike, and not all numbers are repeated in every figure for clarity of the illustration.

FIG. 1 is a cross-sectional view of an exemplary embossing drum.

FIG. 2a is an isometric view of an exemplary releasable journal support.

FIG. 2b is an isometric view of an exemplary modified releasable support.

FIG. 2c is an isometric illustration of an exemplary simple support.

FIG. 3 is a side view of an exemplary modified drum system.

FIG. 4 is a cross-sectional view of another embodiment of a drum system employing a tapered sleeve with the tapered drum.

FIG. 5 is a cross-sectional view of another embodiment of a drum system employing tapered bushings with a cylindrical drum and a cylindrical sleeve.

FIG. 6 is a cross-sectional view of an exemplary, unitary construction embossing drum with the pattern directly on the surface of the drum.

### DETAILED DESCRIPTION

In the film manufacturing industry there is a need for devices and methods that allow for the replacement of embossing drums (and similar devices) in a reduced amount of time. This is desired for the reasons that repair of an embossing drum is time consuming and reduces the efficiency of the manufacturing line. Disclosed herein are embossing drum systems and methods for their use. These systems comprise releasable journal supports and a drum comprising a removable outer sleeve, e.g., a rigid and/or tapered outer sleeve. The system allows for the repair of the drum without requiring the drum to be removed from the machine and decreases the time required to repair a damaged or worn drum, thereby increasing operation efficiency and reducing the difficulties associated with such repairs. More specifically, the system comprises a modified embossing drum and a modified mounting system. The modified embossing drum comprises a cantilevered mandrel and a sleeve. The sleeve comprises a taper on its inside diameter that is configured to mate with a corresponding taper on the outside of the mandrel. This taper allows the embossed sleeve to be removed from one end of the mandrel. To gain access to the end of the mandrel, the modified mounting system comprises a support frame that can be opened, e.g., a clam-shell like support frame, and/or that can be loosened and removed from the mandrel.

In one embodiment, an embossing drum system can comprise: a mandrel having a mandrel outer surface, a primary journal extending from a first end of the mandrel, a secondary journal extending from a second end of the journal, and a seamless sleeve disposed around the mandrel to form a drum. The sleeve comprises a pattern cut into a sleeve outer surface. The system can further comprise a bushing having an internal taper, wherein the mandrel outer surface has an external taper, and wherein the bushing is disposed between the sleeve and the mandrel. In another embodiment, a first bushing has an internal taper and a second bushing has an external taper, wherein the mandrel is cylindrical and the sleeve is cylindrical, and wherein the first bushing is disposed between the mandrel and the second bushing, and the second bushing is disposed between the first bushing and the sleeve. In yet another embodiment, the sleeve has an inner sleeve surface with an internal taper and the mandrel having outer surface with an external taper. In some embodiments, the pattern comprises optical facets having a roughness of less than or equal to about 10 nm that are rounded to a less than or equal to about 2 μm radius. The sleeve can comprise a nickel, and/or copper.

In another embodiment, an embossing drum system comprises: a seamless drum having a substantially constant outer diameter, a primary journal extending from a first end of the mandrel, and a secondary journal extending from a second end of the journal. The drum comprises a pattern cut into an outer surface of the drum. The drum can comprise a core comprising a diamond-turnable material and a coating comprising a environmentally stable material. The coating can comprise nickel, cobalt, silver, aluminum, titanium, iridium, gold, chromium, beryllium, tungsten, tantalum, molybdenum, platinum, palladium, and combinations comprising at least one of the foregoing.

In one embodiment, a method of making optical films, comprises: introducing a polymer to an embossing drum system, forming the pattern into a surface of the polymer to produce a film, and removing the film from the drum. The embossing drum system comprises a drum with a pattern cut into a drum outer surface. The film has a continuous, seamless pattern having a length that is greater than the drum circumference. A backlit display can be formed using this film.

In some embodiments, a drum system can comprise: a drum having a seamless drum outer surface, with a pattern cut into the drum outer surface, a primary journal extending from a first end of the drum, a secondary journal extending from a second end of the drum, and a releasable journal support engaging the secondary journal. The system can further comprise a retaining ring mechanically engaging a first end of the drum adjacent the releasable journal support. The releasable journal support can comprise an upper jaw pivotally attached to a body portion, wherein the secondary journal extends through the releasable journal support between the upper jaw and the body portion.

In other embodiments, the separate electroform is eliminated, thereby eliminating the electroform seam and enabling continuous production of a film (e.g. a film that has a useable area comprising microstructures that has a length that is greater than the circumference of the drum). Hence, the drum can have continuous microstructures around its outer surface; it can be seamless. The continuous outer surface microstructure can be achieved in a few ways: (i) the drum can comprises a negative of the desired pattern (e.g., optical pattern, i.e., a pattern that can be use to form a collimating film) formed directly into the outer surface of the drum, (ii), the microstructures can be formed directly into the sleeve that is disposed over the drum, wherein the sleeve can have a tapered inner diameter and/or a tapered bushing can be located between the sleeve and the mandrel. The microstructures can be microstructures used in collimating sheets. For example, multi-faceted prismatic structures, even those where every facet has a surface roughness of less than or equal to 10 nanometers (nm), and even less than or equal to 5 nm, and so forth). Where the microstructures are disposed on a unitary drum (a solid drum without a removable sleeve), the entire drum can be quickly removed from the embossing machine using the variously described quick release techniques. In the embodiments where the microstructures are located directly on the outer surface of the sleeve, the various quick release and sleeve change techniques described herein can be employed. By disposing the pattern directly onto the drum or sleeve, a continuous film can be produced instead of patch formation. This reduces processing time and waste.

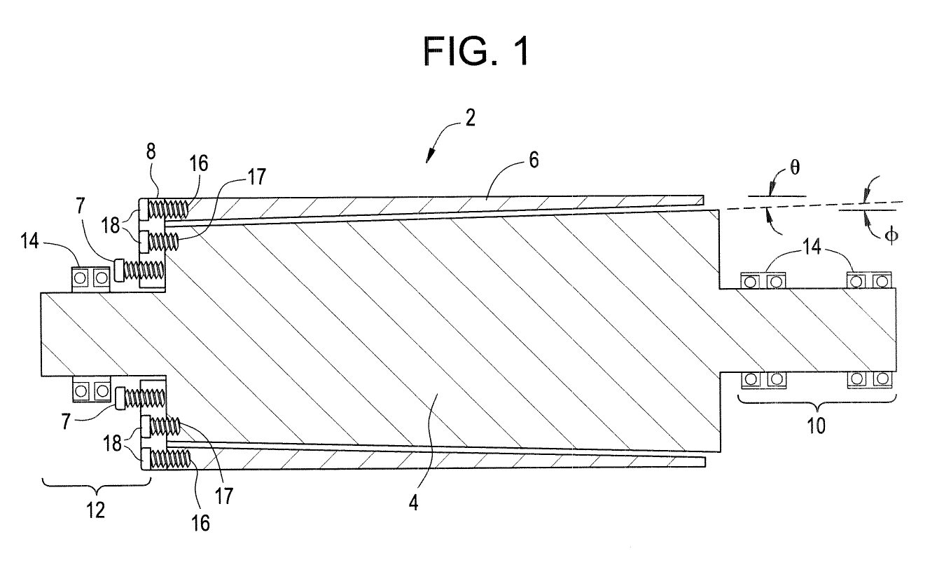

Referring now to FIG. 1, a cross-sectional view of an exemplary embossing drum, generally designated 2, is illustrated. The embossing drum 2 comprises a mandrel 4, from which a primary journal 10 and a secondary journal 12 (hereinafter referred to as “journals”) extend. The journals are capable of supporting the mandrel 4 as the drum 2 can be rotated on bearings 14 disposed on the journals during use. An embossing sleeve 6 is disposed on the mandrel 4. The embossing sleeve 6 comprises an internal taper angle (Φ) that can correspond to the external taper angle (θ) on the mandrel 4, thereby allowing the embossing sleeve to be assembled onto the mandrel 4 over the secondary journal 12 and bearing 14. The sleeve 6 can be fastened (e.g., spring-like fastened) to the mandrel 4 utilizing a retaining ring 8, which can be secured (e.g., bolted, spring-like fastener, and/or otherwise removably attached) to both components.

The mandrel 4 can be formed utilizing various machining processes (e.g., turning, milling, grinding) from materials such as metals (e.g., copper, aluminum, iron, chrome, nickel, cobalt, iron), metal alloys (e.g., martensitic, ferritic, and austenitic stainless materials), and so forth, as well as combinations comprising at least one of the foregoing. In order to manufacture the desired films, the temperature of the drum 2, and hence the mandrel 4 is controlled. As a result, thermal controls (not shown) can be disposed in the mandrel 4. For example, heat transfer fluid channels (e.g., water channels) comprising a heat transfer fluid such as water, a double-shell spiral baffle, heat exchange cartridges, and so forth, can be disposed within the mandrel 4.

The taper angle θ on the outer diameter of the mandrel 4 can be chosen based on several variables, such as the coefficients of thermal expansion of the sleeve 6 and the mandrel 4, and an ability to maximize heat transfer between the mandrel 4 and the sleeve 6. For example, the taper angle θ can be about 0.5 degrees (°) to about 10°, or, more specifically, about 0.5° to about 5°, or, even more specifically, about 0.5° to about 3°; e.g., about 1°.

The mandrel 4 and journals can be formed from one material blank (as shown), or formed separately and joined together. In one such embodiment the journals can comprise a stainless steel shaft onto which an aluminum mandrel 4 can be press-fit. Regardless of assembly and/or production method however, it is desirable that the components of the embossing drum 2 (e.g., mandrel 4, sleeve 6, retaining ring 8, bearings 14) are concentric and balanced to ensure smooth rotation without vibration or misalignment during operation.

The primary journal 14 can comprise a length that can be greater than the length of the secondary journal 12 to allow additional bearing(s) 14 to be assembled thereon. The additional bearings can be added to enable the primary section to support the drum 2 when a releasable journal support on the secondary side is removed to enable the removal of sleeve 6. The length of the journals however can comprise any length that is desired and provides the structural integrity for the particular mandrel 4. For some applications, the length of the journals can be about 2 inches (5 centimeters (cm)) to about 16 inches (41 cm), or, more specifically, about 4 inches (10 cm) to about 12 inches (30 cm). For example, the primary journal 10 can comprise a length of twelve inches (30 cm) and have two bearings 14, and the secondary journal 12 can comprise a length of four inches (10 cm) and have one bearing 14.

The diameter of the journals is dependent on several variables, such as the dimensions and weight of the mandrel 4 and sleeve 6, the strength of the material employed for the journals, and so forth. Therefore, the exact dimensions of the journal will vary with application. For example, in one embodiment, the journals can comprise a diameter of 2.5 inches (6.4 cm) for a 8 inch (20.3 cm) diameter, 24 inch (61 cm) long, mandrel 4, wherein the mandrel 4 and journals comprise 400-series stainless steel, the surface of the drum is chrome-plated, and the sleeve 6 comprises aluminum (e.g., hard-anodized aluminum, and so forth).

The bearings 14 employed on the journals can be designed for an extended service life and can be toleranced to provide low vibration during operation (e.g., sealed, hardened rolling element bearings). The bearings 14 can be assembled onto the journals utilizing any method, such as press-fitting. To enable rapid, facile drum repair, the drum 2 comprises a removable journal support(s) disposed at an end of the mandrel 4. When the removable journal support is unsecured and removed from a journal, the drum 2 is cantilevered from the opposite journal. Therefore, the bearing 14 should be employed that are capable of withstanding the stress when in this configuration.

The retaining ring 8 can be employed to secure the sleeve 6 to the mandrel 4. In the embodiment illustrated, bolts can be employed that can be inserted into holes 18 (e.g., counter-sunk through-holes) disposed on one face of the retaining ring 8. Furthermore, the holes 18 can comprise threads with optional jack(s) 7 (e.g., jack-bolt(s), jack-screw(s), and so forth) disposed therein. During removal of the sleeve 6 from the mandrel 4, the jack(s) 7 can be leveraged against the mandrel 4 to push the retaining ring 8 away from the mandrel 4, thereby simplifying removal of the retaining ring 8. Additionally, the retaining ring comprises hole(s) 18 that align with threaded hole(s) 17 in the mandrel 4. These threaded holes enable fastener(s) to fix the retaining ring 8 to the mandrel 4. The retaining ring 8 can comprise any material such as those described above in relation to the journals. Also, any number and configuration of holes 17 and 18 can be employed. The inside diameter of the retaining ring 8 is desirably a diameter that can fit over the bearing(s) 14 on the secondary journal 12 to enable facile removal of the ring and sleeve during drum repair.

The sleeve 6 is attached so as to co-rotate with the mandrel 4. Therefore, as in FIGS. 1, 3, and 4, the thickness of the sleeve 6 can be configured to accept a tap 16 for a bolt, so that the sleeve 6 can be bolted to a retaining ring 8, and/or otherwise attached to attain co-rotation. The retaining ring in turn is attached to the mandrel 4 via a removable bolt 17. Other methods of removably retaining the sleeve 6 on mandrel 4 can also be employed.

Depending upon the function of the drum 2, the sleeve 6 can have a removable tool (i.e., removably disposed on the sleeve such that it can be removed from the sleeve without damage to the sleeve), such as an electroform and/or other external tool (e.g., rubber surface tool, and so forth) disposed thereon, wherein the tool comprises desired surface features (e.g., microstructures), or can otherwise impart a desired surface to the film produced (e.g., a smooth surface, rough surface, and/or imprinted surface). For example, if the drum 2 will be employed in the production of light enhancement film, and the like, a tool (e.g., an electroform, and so forth) comprising a negative of the desired film surface geometry (e.g., prismatic structures and the like), can be disposed on the sleeve 6. The tool can be disposed on the sleeve 6 before or after the sleeve 6 has been disposed on the mandrel 4. For efficiency, the layer can be disposed on the sleeve 6 prior to the sleeve 6 being disposed on the mandrel 4 so that, when the sleeve on the mandrel needs replacement, the mandrel and layer, can be rapidly replaced. This tool can have a thickness of less than or equal to about 0.01 mm, or, more specifically, less than or equal to about 500 micrometers (μm).

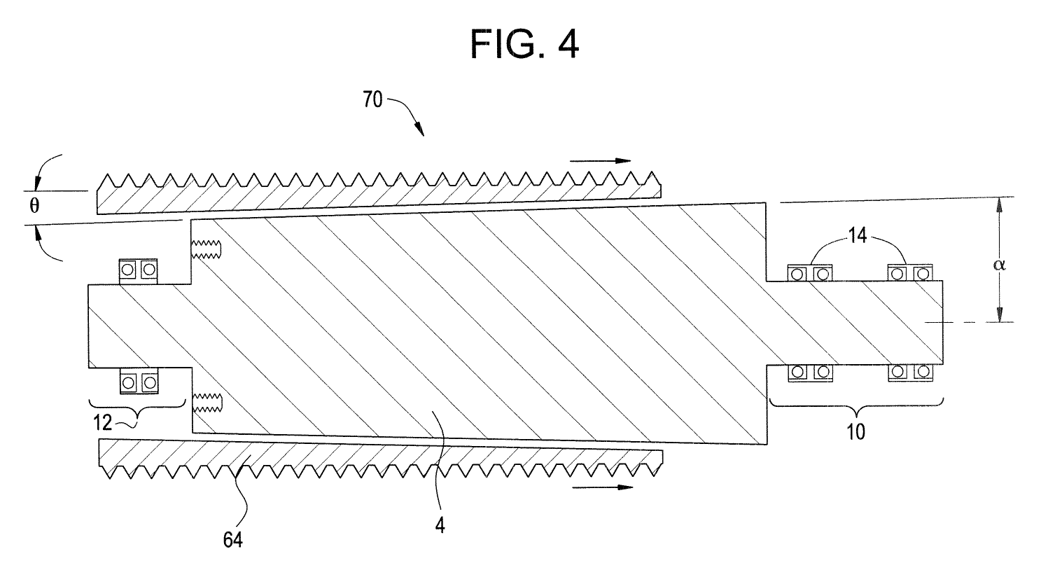

In other embodiments, if the sleeve 6 is used to impart an imprinted surface to the product, the sleeve 6, which can be multilayered (e.g., wherein the layers are not separable or removable without damaging the sleeve; a single, unitary structure), can comprise a pattern directly in the outer surface of the sleeve, as is illustrated in FIG. 4.

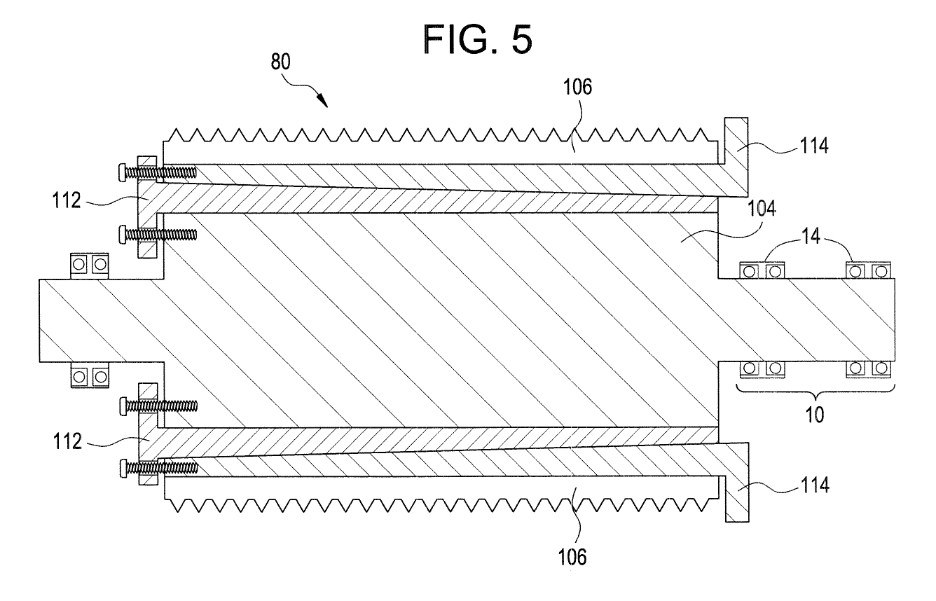

Additionally, as is illustrated in FIG. 5, the drum system 80 can comprise a seamless, cylindrical sleeve 106 disposed around a cylindrical mandrel 104, with tapered bushings 112 and 114 holding the sleeve 106 to the mandrel 104. It is further noted, that a cylindrical sleeve 106 can be employed on a tapered mandrel 4, by employing a tapered bushing having a taper on the inner surface. In this embodiment, the sleeve can be disposed around the mandrel, then the bushing can be slid into place between the sleeve and the mandrel. Where multiple bushings are employed, the sleeve can be disposed on the mandrel, or disposed on the second bushing and then the sleeve with the second bushing can be disposed on the mandrel. Once they are on the mandrel, the first bushing (i.e., the bushing disposed at the releasable journal end of the drum system), can be slid into place. This first bushing can be located between the sleeve and the mandrel, and, depending on the taper (outer surface or inner surface), will be disposed between the sleeve and the second bushing or the second bushing and the mandrel. For ease of assembly, the second bushing can have an inner tapered surface.

As with the tapered mandrel and tapered sleeve discussed above, the bushing(s) can have complimentary taper angles (that compliment the other bushing or the mandrel, as is appropriate). Taper angles can be the same as those discussed above. The tapered bushings simplify the drum system since multiples sleeves will be used per machine, while the bushing(s) can be reused. Additionally, especially when the microstructures are located into the sleeve, a cylindrical sleeve (non-tapered), can simplify fabrication, micromachining, and/or plating, and so forth.

The size and geometry of the sleeve are dependent upon the particular application and the size of the mandrel 4. In some embodiments, the sleeve 6 can have a sufficient thickness to be mounted to the mandrel 4, e.g., receive a fastener (such as a screw), and to be reusable. For example, the sleeve 6 can have a thickness of greater than or equal to about 1.5 millimeters (mm), or, more specifically, greater than or equal to about 3 mm, or, even more specifically, greater than or equal to about 5 mm. In other embodiments, such as were the sleeve is supported by bushing(s), the bushing(s) can retain the sleeve to the mandrel with or without fastener(s).

In some embodiments, the cylinder is seamless and comprises a continuous pattern in the outer surface thereof. In other embodiments, the sleeve 6 can have a generally cylindrical shape that can optionally comprise a slit extending from one end to another end of the sleeve 6 (e.g., a longitudinal slit) to enable the diameter of the sleeve 6 to change as the sleeve 6 is disposed on the mandrel 4. The taper angle Φ of the sleeve 6 can be configured to match the taper angle θ to ensure proper fit and effective heat transfer therebetween. Optionally, the taper angle Φ can be different than the taper angle θ, e.g., less than the taper angle θ to cause the mandrel 4 and sleeve 6 to tightly fit together. A difference in the angles θ and Φ, however, can increase the complexity and time to remove the sleeve 6 from the mandrel 4.

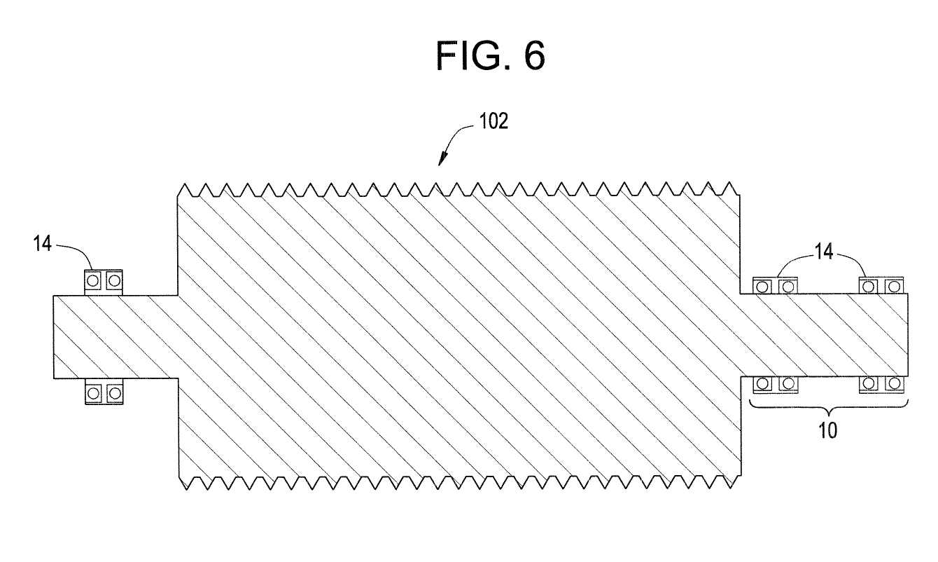

In another embodiment, the drum 102 has the pattern formed directly into the surface thereof, thereby eliminating any seam that might be present on an electroform sleeve attached to the drum. (See FIG. 6) In other words, in this embodiment, a pattern can be formed (e.g., diamond turned) directly into the drum surface. In other words, the drum, pattern, and any coating on the pattern, are not separatable into different components without damaging those components. They are a unitary, seamless component with a microstructure around the outer surface such that a film having a continuous microstructure (without a seam) and having a length greater than the circumference of the drum, can be formed therefrom.

Hence, the drum surface comprises a material that can be diamond turned (such as copper, nickel, phosphorus, aluminum, and the like and combinations comprising at least one of the foregoing), into which the microstructure is machined. The drum or sleeve can be constructed of this material, or alternatively the drum can be constructed of other materials such as steel, and then coated or plated with the diamond-turnable material. If the chosen diamond-turnable material is resistant to environmental damage, such as oxidation, staining, pitting, scratching, denting, and the like, it can be used on the coating machine as is. For example, nickel-phosphorus alloys are both diamond-turnable and environmentally stable, although difficult to diamond-turn. On the other hand, if the material is not environmentally stable (such as copper which is easily diamond-turnable but is soft and oxidizes and stains easily), then a thin protective metal coating can be applied after diamond-turning to protect the surface and/or the surface can be passivated, so that the thin uniform oxide layer formed by the passivation process serves as the protective coating on the drum (e.g., on the copper).

The diamond-turnable coating into which the microstructure is machined can be sufficiently thick to contain the cut microstructure, and desirably thick enough to allow for re-use so that multiple cutting operations and use in production can be achieved before the coating is too thin and must be re-plated. For example, the thickness can be about 0.1 to about 5 mm. If the diamond-turnable material is not environmentally stable, the metal protective overcoat is thin and smooth such that the optical precision of the microstructure is preserved. Typically optical facets must remain smooth to a roughness of less than or equal to about 10 nm, and sharp features cannot become rounded to greater than or equal to an about 2 micrometer (μm) radius. The coating can be a hard, dense, and resistant to the environment. For example, the coating can be metal(s) such as those described in relation to the sleeve having the microstructures, such as chrome, nickel, nickel-cobalt alloys, nickel-phosphorus alloys, and the like.

The materials of the sleeve and the drum depend upon the particular use and the forming technique (e.g., whether or not the microstructures are formed into the surface thereof). Possible materials include metal(s) (e.g., copper, aluminum, iron, nickel, chrome, cobalt), as well as alloys comprising at least one of the foregoing; polymeric material(s) (thermoplastics and/or thermoset). For example, the material can be rubber, or can comprise martensitic, ferritic, and/or austenitic stainless. The sleeve or drum could also be multilayered, such as steel, aluminum, as well as other materials that impart sufficient structural integrity for the desired process, with a surface-coating (outer layer) of a material capable of comprising the desired pattern. For example, the surface coating can comprise nickel (Ni), cobalt (Co), copper (Cu), silver (Ag), iron (Fe), aluminum (Al), titanium (Ti), iridium (Ir), chromium (Cr), beryllium (Be), tungsten (W), tantalum (Ta), molybdenum (Mo), platinum (Pt), palladium (Pd), gold (Au), among others, as well as combinations comprising at least one of the foregoing; e.g., copper with a surface coating of chromium and/or nickel, and so forth. Some possible alloys include a nickel-phosphorus (NiP) alloy (e.g., comprising about 5 wt % to about 25 wt % P based upon a total weight of the alloy, or, more specifically, about 8 wt % to about 20 wt % P, or, even more specifically, about 10 wt % to about 15 wt % P), a palladium-phosphorus (PdP) alloy, a cobalt-phosphorus (CoP) alloy, a nickel-cobalt (NiCo) alloy, a gold-cobalt alloy (AuCo), and a cobalt-tungsten-phosphorus (CoWP) alloy.

The pattern (e.g., microstructures with nanoscale resolution such as light-reflecting elements (cube-corners (e.g., triangular pyramid), trihedral, hemispheres, prisms, ellipses, tetragonal, grooves, channels, and others, as well as combinations comprising at least one of the foregoing)) can be disposed on the sleeve (FIGS. 4 and 5) or on the drum (FIG. 6) via various techniques, such as machining (e.g., micromachining), lithography (e.g., photolithography), etching, deposition, laser-writing, diamond cutting, and so forth. Diamond cutting is generally employed in order to attain the desired nanoscale resolution and facet edge radius.

Depending upon the material of the drum, if the pattern is formed into the outer surface of the drum, once the pattern is formed, a coating can be formed over the drum to inhibit oxidation, and/or enhance the structural integrity of the features forming the pattern. The pattern can include features having microstructures with a size of less than or equal to about 100 micrometers (μm). Furthermore, such microstructures such as prisms have facets that are optically flat and smooth, with surface roughness, Rₐ of less than or equal to about 50 nm, or, more specifically, less than or equal to about 25 nm, or, even more specifically, less than or equal to about 10 nm, and, yet more specifically, less than or equal to about 5 nm.

The coating(s) can be disposed over the pattern using various coating processes capable of forming a coating that conforms to and retains the nanoscale resolution of the pattern, and that has the desired average surface roughness (Ra), e.g., an Ra of less than or equal to about 10 nm. Exemplary coating techniques include plating (e.g., electroless plating, electrolytic plating, and the like), vapor deposition, sputtering, and spraying (e.g., plasma spray deposition), or alternately simply chemical or electrochemical passivation (e.g., that enables controlled formation of an oxide layer (e.g., a thin uniform oxide layer)). For example, an aluminum cylinder core can be electrolytically plated with copper (e.g., UBAC copper), to form a drum, e.g., with about 1.5 millimeters of copper. The drum can then be diamond-turned to form prismatic microstructures into the copper prior to electrolytically plating the drum with either chromium or nickel-cobalt alloy, e.g., to 10 nm to 1,000 nm thick.

The diamond-turned drum can then be plated in various processes, including an electroplating process. The electroplating process can be performed in an electroplating tank where the outer surface of the drum functions as the cathode through electrical contacts. The anode can be constructed from various metals, including the metal to be deposited during metallization. For example, a nickel anode or nickel alloy can be used if nickel is the desired metal in the metallization process. For example, the drum can be placed into an electroplating solution and optionally rotated (e.g., up to about 10 revolutions per minute (rpm) or so) to more uniformly deposit the metal. A rectifier in electrical communication with the anode and cathode can be maintained constant during this process or it can be adjusted. The electroplating can be accomplished in up to about 24 hours.

The solution in the electroplating tank can be an aqueous solution comprising a surfactant agent, a pH of less than or equal to about 6, and optionally a hardening agent. The solution will further comprise the metal(s) to be deposited. One embodiment of a solution can comprise about 60 grams per liter (g/l) to about 100 g/l of metal sulfamate (e.g., the metal to be deposited), sufficient acid to attain a pH of less than or equal to about 6, a sufficient amount of surfactant agent to affect wetting of the metallic surface to be coated, and optionally a hardening agent, e.g., to control stress in the deposit. For example, the solution can comprise about 70 g/l to about 90 g/l nickel sulfamate, about 25 g/l to about 35 g/l boric acid, and sufficient sulfamic acid to attain a pH of about 2 to about 5.0.

When a current is applied to the system, the anodic metal oxidizes to form metal ions which then flow to the cathode (the outer surface of the drum) and deposit thereon. The cathode then reduces the metal ion into elemental metal. The following shows the reactions at the anode and cathode for nickel:
anode: Ni⁰−2e⁻→Ni²⁺
cathode: Ni²⁺+2e⁻→Ni
Electroplating of other metals also go through similar reactions at the anode and cathode. Some of the possible metals for the electroplating process include those described above for coating the drum.

Electroplating process parameters include solution temperature, composition, and rectifier voltage. Regarding the temperature, the solution in the electroplating tank can optionally be heated to about 30° C. to about 80° C., or, more specifically, about 35° C. to about 60° C., or, even more specifically, about 40° C. to about 50° C. The rectifier can be used to apply a sufficient voltage to the electrodes to induce an electric current to cause anodic oxidation of the metal to be deposited, and to reduce the metal ions at the cathode. For the formation of a Ni or Ni alloy coating, for example, the current density can be about 2 amperes per square foot (ASF) to about 100 ASF or so, or, more specifically, about 5 ASF to about 60 ASF or, even more specifically, about 10 ASF to about 30 ASF.

The exposure time in the electroplating tank while the current is applied can be determined based upon the particular metal coating to be formed and the desired thickness of that coating. The coating thickness can be based upon a desired structural integrity and based upon the size of the features formed in the surface of the coating. Thicknesses can be up to and exceeding about 500 micrometers (μm) or so, or, more specifically, about 50 μm to about 400 μm, or, even more specifically, about 100 μm to about 300 μm, and, yet more specifically, about 150 μm to about 250 μm.

By controlling the processing parameters of the electroplating, the thickness of the deposited metal coating can be adjusted. The thickness of this metal coating can be calculated from the equation:

$$T = ( \frac{M \cdot I \cdot t}{\vert Z \vert F ρ A} )$$

where: T=thickness of the electroplated coating;

M=the molar mass of the metal;

I=the current;

t=the time of electroplating;

|Z|=the absolute value of the valence of the metal;

F=Faraday constant;

ρ=the density of the metal; and

A=the surface area to be covered by the metal.

This equation gives a theoretical maximum thickness assuming 100% efficiency of the cathode. However, because electrodes are not always 100% efficient, the actual thickness is usually less than that calculated by the equation. Generally, the efficiency of an electrode is about 95% to about 99% depending on the material used as well as other factors.

Once the desired thickness is achieved, rectifier is switched off and the cylinder is removed from the electroplating tank. Optionally, the coated master is rinsed, e.g., with water (such as deionized water (i.e., water that has been treated with an ion exchange resin to remove ions therefrom)), and retained in an inert environment (e.g., an environment that does not chemically interact with the sub-master surface to change the surface chemistry under the environmental conditions). Some possible inert environments include nitrogen, argon, helium, vacuum, and others, depending upon the environment.

Another method of protecting the surface of the drum or sleeve is passivation, which is the formation of an oxide and/or hydroxide coating over the drum surface by means of chemical and/or electrochemical techniques. Formation of an oxide coating can comprise an electrolytic oxidation process wherein the electrolytic current and voltage are applied to form a controlled thickness oxide coating. Chemical passivation can comprise immersing the drum surface in a solution for a controlled period of time. The particular solution is dependent upon the drum composition. Some possible solutions include alkali metal hydroxide solutions, chromate (such as potassium dichromate), among others.

For example, the surface of the drum can optionally be rinsed with Simple Green solution (commercially available from Sunshine Makers, Inc., located in Huntington Beach, Calif.) and then sprayed with a saponin solution to promote wetting of the surface. A potassium dichromate solution (e.g., about 5 grams per liter (g/l)) can be applied to the surface of the drum (e.g., poured over the surface). The potassium diclromate is then rinsed from the drum surface to form a passivated drum surface. Optionally, the saponin and potassium dichromate applications can be repeated as desired.

In the following examples, an aluminum drum was plated with about 1.5 mm of copper of about 220 vickers hardness. It was then diamond-turned with a prismatic structure. Each drum was then acid-cleaned and electroplated with nickel-cobalt alloy, after which the surface roughness was measured using an optical surface profilometer. The results are in Table 1. The data for Samples 1 and 3 were overplated copper foils, whereas the Sample 2 and 4 results were for actual drums. The results show that the surface roughness can be kept below 10 nm, and even below 5 nm, after a protective plating has been applied. The measurements were obtained using an optical surface profilometer (MicroXAM surface profiler, ADE Phase Shift, Tucson, Ariz.).

TABLE 1

| | Plating thickness | Surface roughness |
|---|---|---|
| Sample | (nm) | (Ra, nm) |
| 1 | none | 3.1 |
| 2 | 70 | 4.3 |
| 3 | 250 | 5.4 |
| 4 | 350 | 7.5 |

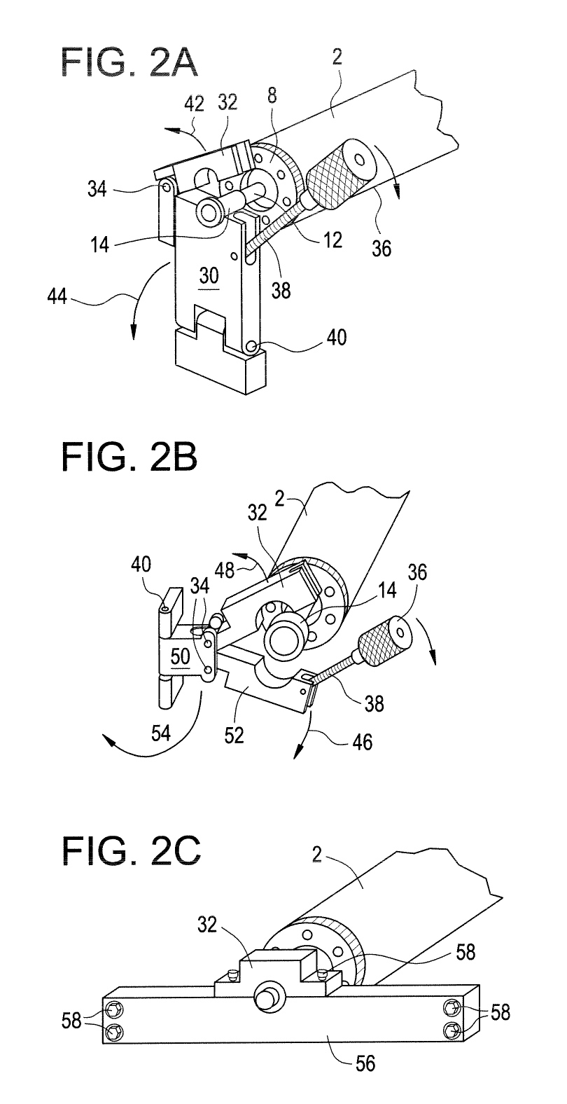

Referring now to FIG. 2a that shows an isometric view of an exemplary releasable journal support. The drum 2 is supported by a releasable journal support 30 that contacts the bearing 14 located on the secondary journal 12. The releasable journal support 30 comprises an upper jaw 32 that is capable of opening at a pivot shown by the directional arrow 42. A collar 36 is disposed on a threaded rod 38 that can be employed to secure the upper jaw 32 onto the bearing 14. When the upper jaw 32 is released (unsecured), the releasable journal support 30 can be rotated away from the drum 2 via hinge 40 e.g., in the direction illustrated by the directional arrow 44. Once away, the bolts (not shown) employed to secure the retaining ring 8 to the mandrel 4 can be removed and the sleeve 6 can be removed from the mandrel 4 (jack-bolts can optionally be used to pull the sleeve 6 from the mandrel).

The releasable journal support 30 can comprise any design that is capable of being removed from the drum on the side from which the sleeve 6 is to be removed; i.e., the side where the inner diameter of the sleeve is the smallest.

FIG. 2b illustrates an isometric view of another embodiment of a releasable support; a modified releasable support. The modified releasable support 50 comprises an upper jaw 32 and a lower jaw 52, which are free to open away from the bearing 14 (indicated by the directional arrows 46,48) at pivots 34. The upper jaw 32 and lower jaw 52 are also capable of securing bearing 14 via a collar 36 that is attached to a threaded rod 38. In addition, when the upper jaw 32 and lower jaw 52 are unsecured, the modified releasable support 50 can swing away form the bearing 14 via a hinge 40, as indicated by the directional arrow 54.

Yet another embodiment of the releasable support is illustrated in FIG. 2c. In this embodiment, the upper jaw 32 can be bolted to a simple support 56 via bolts 58. The simple support 56 can be bolted to the frame (not shown) of the production equipment via bolts 58. To gain access to the drum 2, the bolts 58 securing the upper jaw 32 can be removed, and the simple support 56 can also be removed by removing the bolts therein.

The releasable journal support 30, modified releasable support 50, and simple support 56 (hereinafter referred to as “releasable journal supports”) can comprise materials such as those described above in relation to the journals. Desirably, the releasable journal supports are fabricated to resist wear, which can cause misalignment of the journals and/or premature bearing failure over a prolonged service life.

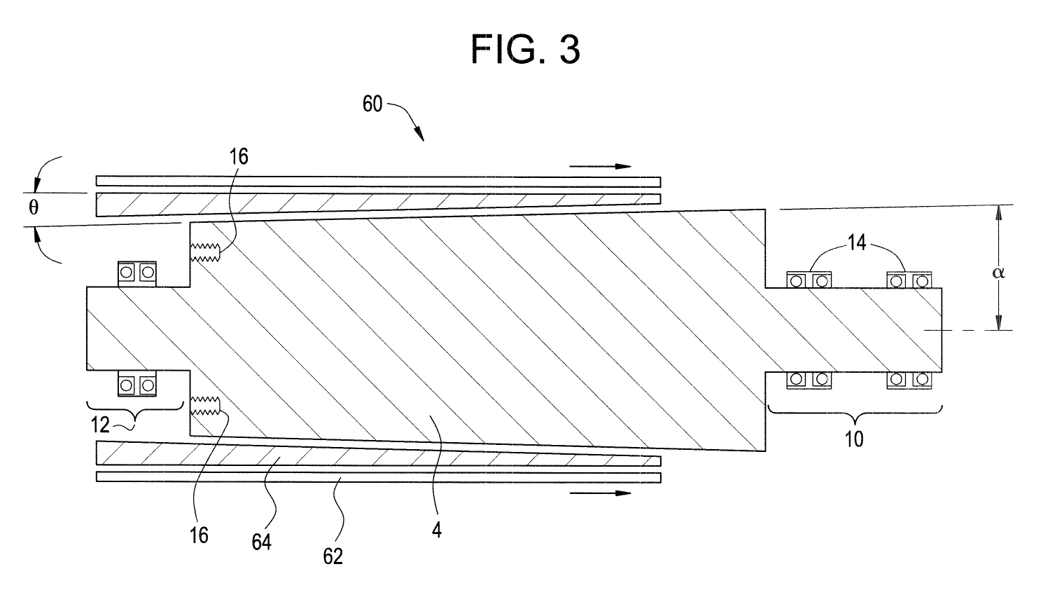

Referring now to FIG. 3, a side view illustrating an exemplary modified drum system generally designated 60. A sleeve 64 is disposed partially assembled onto a mandrel 4. The sleeve 64 comprises an internal taper angle that is equivalent to the mandrel taper angle θ. The outside diameter of the sleeve 64 is concentric with the mandrel 4 and a constant diameter (non-tapered). The sleeve 64 also comprises a slit (not shown), which is disposed along the entire length of the sleeve 64 so that as the sleeve 64 is advanced onto the mandrel 4, the sleeve 64 can expand in diameter. Disposed around the sleeve 64 can be an electroform 62. The electroform 62 comprises a tubular shape that can comprise an embossing pattern on its outer surface and a smooth bore on its inner surface. The electroform 62 can be secured to the modified drum 60 by advancing the sleeve 64 onto the mandrel 4 as indicated by the directional arrows. The sleeve 64 expands in outer diameter as it is advanced onto the mandrel 4. The expanding sleeve 64 can engage the electroform 62 to secure the electroform 62 onto the mandrel 4. The retaining ring 8 can then be bolted to the mandrel 4 and/or to the sleeve 64.

The sleeve 64 and electroform 62 can the toleranced to minimize the width of the slit once the sleeve 64 have been disposed on the mandrel 4. Since the portion of electroform 62 spanning the slit is unsupported, and if the slit is wide, the electroform 62 can deflect under the pressure of the film manufacturing process and yield a recurring blemish on the film product. The width of the slit once the sleeve 64 has been assembled onto the mandrel 4 can be less than or equal to about 0.5 inches (1.3 cm), or, more specifically, less than or equal to about 0.25 inches (0.6 cm), and even more specifically, less than about 0.1 inches (0.2 cm).

As discussed above, the drum 102 comprising the pattern, which eliminates an electroform seam, can also be employed with the above described releasable supports, whereby the entire drum 102 is removed and replaced using the releasable support. In this embodiment, releasable supports can be located on both sides of the drum to release the drum and bearings from their supports.

The electroform 62 can be formed utilizing typical electroforming processes, or could be a plastic tool formed by a molding, pressing, machining, grinding, and/or other process. The electroform can comprise metals such as nickel (Ni), cobalt (Co), copper (Cu), iron (Fe), aluminum (Al), titanium (Ti), iridium (Ir), gold (Au), chromium (Cr), beryllium (Be), tungsten (W), tantalum (Ta), molybdenum (Mo), platinum (Pt), palladium (Pd), among others, as well as alloys comprising at least one of the foregoing metals, and mixtures comprising at least one of the foregoing metals. Some possible alloys include a nickel-phosphorus (NiP) alloy, a palladium-phosphorus (PdP) alloy, a cobalt-phosphorus (CoP) alloy, a nickel-cobalt (NiCo) alloy, and a cobalt-tungsten-phosphorus (CoWP) alloy. For example, in one embodiment, the sleeve 64 can comprise aluminum that is anodized for increased wear resistance, and the electroform 62 can comprise a nickel-cobalt alloy and can have a thickness of 50 micrometers (μm) to about 500 μm.

Previously, drum repair and/or electroform replacement was time consuming and difficult. For example, a casting drum would have a smooth surface with the electroform attached by double-sided tape. Repair and replacement would require the operator to strip off the electroform, strip off the tape, clean adhesive residue off of the roll, then to apply new tape and finally the new electroform. Great care would need to be taken to apply both tape and electroform smoothly; i.e., with no wrinkles or air pockets that could cause defects. If there are any defects, the tool and tape would be stripped off and the process would be repeated.

Another way an electroform was mounted was to use a clamping mechanism on the surface of the drum to grip the ends of the electroform. In this case, the operator would still have to mount the tool by hand. The disadvantage of this process was that the clamping mechanisms were bulky and inhibited good heat transfer between the drum and the electroform. Additionally, removal of the electroform could be difficult due to the difficulty of accessing the bulky clamping mechanism.

Disclosed herein, embossing drum systems comprise removable sleeves/films and releasable journal supports that can reduce costly downtime of production equipment and allow for easier drum system repair. Furthermore, these drum systems can be retrofitted on existing production equipment to provide these benefits on older equipment as well. It is to be noted the drum systems described herein can be used in various applications, including as a hot press roller, a film guide roller, an imprinting roller, a chill roller, and so forth.

It is also noted that a coating process (e.g., ultraviolet (UV) cast and cure process) can be used for making films (e.g., prismatic brightness enhancement films). The UV-curable liquid resin is sandwiched between plastic film supplied from a roll and a tool (e.g., an electroform) attached to the surface of a temperature-controlled casting drum. The resin fills this “tool” or “mold” so that when it is cured via UV light and stripped from the tool, the coating on the plastic film is a replica of the tool. This tool is a discrete rectangular piece so that coating must be applied in patches aligned with the tool. Issues with this process can include: overcoating the ends of the tool can cause it to be ripped from the drum or damaged; patch coating requires a more complex coating machine; creating the tooling uses an electroforming operation, additional complexity; there is much waste of materials and machine capacity; the area between patches and the starting and trailing ends of the patches are scrap; and most times the product size (rectangular pieces that fit one particular LCD display) does not make efficient use of the patch size generating much more scrap.

As noted above, the surface features can be disposed in the sleeve, e.g., a multilayer sleeve. It is also understood that the surface features can be disposed directly into the mandrel. The surface features can be disposed directly into the sleeve or mandrel with various processes such as such as machining (e.g., micromachining, diamond-machining, and so forth), lithography (e.g., photolithography), etching, deposition, laser-writing, and so forth. Optionally, a thin layer (e.g., less than or equal to about 10 μm thick, or, even more specifically, about 1 nanometer (nm) about 1 μm thick), can be disposed over the surface features, e.g., to enhance the hardness and/or chemical stability of the surface features.

Materials for the sleeve, mandrel, and any thin layer include the materials described above for the sleeve, electroform, and surface layer. For example, the material(s) can be materials that enable: a thin, uniform, surface coating having sufficient density so as to not change the optical properties of the microstructure (e.g., tips remain sharp), with an average surface roughness (Ra) of less than or equal to about 10 nm; the surface is scratch-resistant and chemical resistant (e.g., chemically inert in relation to the coating materials), for example, as compared to copper; and/or where no surface layer (e.g., thin layer) is employed, the base material(s) can themselves be scratch-resistant and chemical resistant, and can be diamond-turntable to give equivalent tip sharpness and surface roughness.

Use of the surface features directly in the sleeve and/or mandrel allows for efficient mass production of microstructured plastic films, eliminates the need for an electroforming (or other tool) factory, simplifies the equipment, and eliminates the need to address tool seams and patch coating. This technique and equipment can greatly improve materials usage efficiency and coating machine capacity, e.g., each improvement by a factor of about 2 to 3 times.

Ranges disclosed herein are inclusive and combinable (e.g., ranges of “up to about 25 wt %, or, more specifically, about 5 wt % to about 20 wt %”, is inclusive of the endpoints and all intermediate values of the ranges of “about 5 wt % to about 25 wt %,” etc.). “Combination” is inclusive of blends, mixtures, derivatives, alloys, reaction products, and the like. Furthermore, the terms “first,” “second,” and the like, herein do not denote any order, quantity, or importance, but rather are used to distinguish one element from another, and the terms “a” and “an” herein do not denote a limitation of quantity, but rather denote the presence of at least one of the referenced item. The modifier “about” used in connection with a quantity is inclusive of the state value and has the meaning dictated by context, (e.g., includes the degree of error associated with measurement of the particular quantity). The suffix “(s)” as used herein is intended to include both the singular and the plural of the term that it modifies, thereby including one or more of that term (e.g., the colorant(s) includes one or more colorants). Reference throughout the specification to “one embodiment”, “another embodiment”, “an embodiment”, and so forth, means that a particular element (e.g., feature, structure, and/or characteristic) described in connection with the embodiment is included in at least one embodiment described herein, and may or may not be present in other embodiments. In addition, it is to be understood that the described elements can be combined in any suitable manner in the various embodiments.

All cited patents, patent applications, and other references are incorporated herein by reference in their entirety. However, if a term in the present application contradicts or conflicts with a term in the incorporated reference, the term from the present application takes precedence over the conflicting term from the incorporated reference.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from essential scope thereof. Therefore, it is intended that the invention not be limited to the particular embodiment disclosed as the best mode contemplated for carrying out this invention, but that the invention will include all embodiments falling within the scope of the appended claims.

What is claimed:

1. An embossing drum system, comprising:
a mandrel having a mandrel outer surface;
a primary journal extending from a first end of the mandrel;
a secondary journal extending from a second end of the journal; and
a seamless sleeve disposed around the mandrel to form a drum, wherein the sleeve comprises a pattern cut into a sleeve outer surface.

2. The system of claim 1, further comprising a bushing having an internal taper, wherein the mandrel outer surface has an external taper, and wherein the bushing is disposed between the sleeve and the mandrel.

3. The system of claim 1, further comprising a first bushing having an internal taper and a second bushing having an external taper, wherein the mandrel is cylindrical and the sleeve is cylindrical, and wherein the first bushing is disposed between the mandrel and the second bushing, and the second bushing is disposed between the first bushing and the sleeve.

4. The system of claim 1, wherein the sleeve has an inner sleeve surface with an internal taper and the mandrel having outer surface with an external taper.

5. The system of claim 1, wherein the pattern comprises optical facets having a roughness of less than or equal to about 10 nm that are rounded to a less than or equal to about 2 μm radius.

6. The system of claim 1, wherein the sleeve comprises a nickel.

7. The system of claim 1, wherein the sleeve comprise copper.

8. An embossing drum system, comprising:
a seamless drum having a substantially constant outer diameter, wherein the drum comprises a pattern cut into an outer surface of the drum;
a primary journal extending from a first end of the mandrel; and
a secondary journal extending from a second end of the journal.

9. The system of claim 8, wherein the drum comprises a core comprising a diamond turnable material and a coating comprising a environmentally stable material.

10. The system of claim 9, wherein the coating is selected from the group consisting of material selected from the group consisting of nickel, cobalt, silver, aluminum, titanium, iridium, gold, chromium, beryllium, tungsten, tantalum, molybdenum, platinum, palladium, and combinations comprising at least one of the foregoing.

11. A method of making optical films, comprising:
introducing a polymer to an embossing drum system, wherein the embossing drum system comprises a drum with a pattern cut into a drum outer surface, wherein the drum has a circumference;
forming the pattern into a surface of the polymer to produce a film; and
removing the film from the drum;
wherein the film has a continuous, seamless pattern having a length that is greater than the circumference.

12. An optical film produced by the method of claim 11.

13. A backlit display comprising the film of claim 12.

14. A drum system, comprising:
a drum having a seamless drum outer surface and with a pattern cut into the drum outer surface;
a primary journal extending from a first end of the drum;
a secondary journal extending from a second end of the drum; and
a releasable journal support engaging the secondary journal.

15. The system of claim 14, further comprising a retaining ring mechanically engaging a first end of the drum adjacent the releasable journal support.

16. The embossing drum system of claim 14, wherein the releasable journal support comprises an upper jaw pivotally attached to a body portion, wherein the secondary journal extends through the releasable journal support between the upper jaw and the body portion.
